(19) United States
(12) Patent Application Publication
(10) Pub. No.: US 2004/0042819 A1
(43) Pub. Date: Mar. 4, 2004

(54) Medium supplying apparatus

(75) Inventor: Naomi Kobayashi, Tokyo (JP)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: Oki Data Corporation

(21) Appl. No.: 10/652,425

(22) Filed: Aug. 29, 2003

(30) Foreign Application Priority Data
Aug. 30, 2002 (JP) JP2002-255183

(51) Int. Cl. G03G 21/00

(52) U.S. Cl. 399/124

(57) ABSTRACT

The present invention provided an medium supplying apparatus which can make medium be removed easily and can prevent that medium is sent slantingly or badly from happening. The medium supplying apparatus comprises a first frame and a second frame set such as rotating freely with respect to the first frame. The first frame includes a first rotating section set such as rotating freely, a first fulcrum coupling section constructing a rotating fulcrum and a first lock coupling section. The second frame includes a pressing member, a second fulcrum coupling section constructing the rotating fulcrum by being coupled with the first fulcrum coupling section, and a second lock coupling section coupled selectively with the first lock coupling section. Because the first and second lock coupling sections are coupled selectively by relative movement, the second frame is locked or unlocked with respect to the first frame.

### BACKGROUND OF THE INVENTION

1. Field of the Invention

The invention relates to a medium supplying apparatus.

2. Related Background Art

Conventionally, In image forming apparatus, for example, printing apparatus, copying apparatus or facsimile apparatus, in order to supply sheets serving as medium, a medium supplying apparatus is installed. The medium supplying apparatus comprises a reversing unit to reverse the sheet for recording on both sides of the sheet.

FIG. 2 is a summary drawing showing a conventional printing apparatus.

In FIG. 2, 11 is the printing apparatus, 12 is a sheet cassette; 13 is a sheet supplying roller which is set at the front end (that is, the right end in FIG. 2) for sending out the sheet (not shown) to a conveyance route Ra; 14 is a conveyance roller for conveying the sheet sent out; 15 is a registry roller, 16 is a photoconductor drum; 16a is a transferring roller set such as pressing upon the photoconductor drum 16; and 17 is a fixing device. The fixing device 17 includes a heating roller 52 and a pressure roller 53.

Further, 18 is separator which is set at the position a or the position b and is used for making alternatively the conveyance route Ra join with a conveyance route Rb or with a conveyance route Rc; and 19 is a reversing unit used for duplex printing.

The reversing unit 19 includes an upper frame 20 and a under frame 21. On the upper frame 20, a plurality of pinch rollers 22 are installed; and on the under frame 21, a plurality of conveyance rollers are mounted. Further, in the reversing unit 19, a reversing roller 54 is set for reversing the sheet conveyed from the conveyance route Rb and for sending the conversed sheet to a conveyance route Rd.

Moreover, the upper frame 20 is installed at a fulcrum 27 such as opening and shutting freely. When the upper frame 20 is set horizontally at a shutting position such as facing to the under frame 21, the each pinch roller 22 is pressed against the corresponding conveyance roller 23 by springs (not shown)

Next, to explain the operations of the printing apparatus with the above construction.

In the case to perform the duplex printing, first, the sheet is sent out from the sheet cassette 12 by the sheet supplying roller 13, and is conveyed to the conveyance route Ra by the conveyance roller 14. Then, the sheet is printed on its one side and is conveyed to the separator 18. At this time, the separator 18 is set at the position a, so the sheet is sent toward the reversing unit 19.

Further, after the sheet is reversed and is conveyed to the conveyance route Rd between the upper frame 20 and the under frame 21 by these pinch rollers 22 and these conveyance rollers 23, the sheet is sent out again by the sheet supplying roller 13 and is conveyed again to the conveyance route Ra by the conveyance roller 14. Then, the sheet is printed again on its other side and is conveyed again to the separator 18. At this time, the separator 18 is set at the position b, so the sheet is sent to the conveyance route Rc and is output the outside of the printing apparatus 11.

In such reversing unit 19, the upper frame 20 can be locked at the under frame 21. Accordingly, on either of the right end and the left end (in FIG. 2, the front end and the behind end) of the under frame 21, a lock lever 26 is mounted such as rotating round a fulcrum 55. On the lock lever 26, a ditch 56 is formed. Further, corresponding to the ditch 56, on the upper frame 20, a coupling bar 28 is mounted.

When the lock lever 26 rotates along a counterclockwise direction, the upper frame 20 is locked; on the contrary, when the lock lever 26 rotates along a clockwise direction, the upper frame 20 is unlocked. Moreover, by using a spring 25 in the lock lever 26, the lock lever 26 is accompanied along the clockwise direction. Thus, when the upper frame 20 rotates to the shutting position, the upper frame 20 is locked automatically at the under frame 21.

Then, when the reversing unit 19 is clogged with sheet, it is needed to pull out the reversing unit 19 from the printing apparatus 11, then to make the lock lever 26 rotate, further to unlock the upper frame 20 with respect to the under frame 21. Thus, by making the upper frame 20 rotates to an inclining position i.e. an opening position with respect to the under frame 21, it is possible to remove the sheet.

However, in the conventional printing apparatus 11, because the lock lever 26 is set at both ends (in FIG. 2, the front end and the behind end) of the right and left of the under frame 21, it is necessary to use both hands to operate the lock lever 26 for locking or unlocking the upper frame 20. Thereby, the work for opening or shutting the upper frame 20 is troublesome. Thus, the work for removing the sheet is also troublesome.

Further, in the case to using such lock lever 26, because it is needed to couple each ditch 56 with the corresponding coupling bar 28, when either of the ditches 56 is not certainly coupled with the corresponding coupling bar 28, it is impossible to lock certainly the upper frame 20 with the under frame 21. Thus, there are some possibilities that the sheet will be sent slantingly or badly.

### SUMMARY OF THE INVENTION

To solve the conventional problems as mentioned above, the present invention supplies a medium supplying apparatus not only capable of removing easily medium, for example, sheet, but also capable of preventing the slanting movement of the sheet or the bad transference of the sheet from happening.

According to the invention, there is provided an medium supplying apparatus, comprising:

a first frame which includes a first rotating section set such as rotating freely, a first fulcrum coupling section constructing a rotating fulcrum and a first lock coupling section;

a second frame which is set such as rotating freely with respect to the first frame and which includes a pressing member, a second fulcrum coupling section constructing the rotating fulcrum by being coupled with the first fulcrum coupling section, and a second lock coupling section coupled selectively with the first lock coupling section,

wherein the first lock coupling section and the second lock coupling section are coupled selectively by relative movement so as to lock or unlock the second frame with respect to the first frame.

In the medium supplying apparatus, the first rotating section and the pressing member are coupled while the first lock coupling section and the second lock coupling section are coupled, a medium is conveyed by the first rotating section.

Further, in the medium supplying apparatus, the first fulcrum coupling section includes a first fitting portion used for regulating the rotation operations of the second frame with respect to the first frame, and a second fitting portion used for allowing the rotation operations of the second frame with respect to the first frame.

Moreover, in the medium supplying apparatus, the first lock coupling section includes an accepting portion for accepting the second lock coupling section, and a fitting portion coupled with the second lock coupling section.

Further, in the medium supplying apparatus, the first frame and the second frame construct a medium conveyance unit, the second frame is moved with respect to the first frame and the coupling situation of the first lock coupling section and the second lock coupling section is changed, by moving the medium conveyance unit.

The above and other objects and features of the present invention will become apparent from the following detailed description and the appended claims with reference to the accompanying drawings.

### BRIEF DESCRIPTION OF THE DRAWINGS

FIG. 1 is a front drawing showing the main part of a reversing unit of the present invention in embodiment 1, which is placing in a situation whose upper frame is set at a shutting position;

FIG. 2 is a summary drawing showing a conventional printing apparatus;

FIG. 3 is a perspective drawing showing the main part of the reversing unit in embodiment 1;

FIG. 4 is a front drawing showing the main part of a reversing unit of the present invention in embodiment 1, which is placing in a situation whose upper frame is set at a opening position;

FIG. 5 is a first perspective drawing showing the coupling situation of a projecting section of the present invention in embodiment 1;

FIG. 6 is a second perspective drawing showing the coupling situation of a projecting section of the present invention in embodiment 1;

FIG. 7 is a perspective drawing showing the setting situation of a pinch roller of the present invention in embodiment 1;

FIG. 8 is a cross-sectional drawing showing the setting situation of a pinch roller of the present invention in embodiment 1;

FIG. 9 is a explanation drawing indicating the relation between a pinch roller and a conveyance roller of the present invention in embodiment 1;

FIG. 10 is a first explanation drawing for explaining the operations when the upper frame is set at the shutting position in embodiment 1;

FIG. 11 is a second explanation drawing for explaining the operations when the upper frame is set at the shutting position in embodiment 1;

FIG. 12 is a third explanation drawing for explaining the operations when the upper frame is set at the shutting position in embodiment 1;

FIG. 13 is a fourth explanation drawing for explaining the operations when the upper frame is set at the shutting position in embodiment 1;

FIG. 14 is a fifth explanation drawing for explaining the operations when the upper frame is set at the shutting position in embodiment 1;

FIG. 15 is a sixth explanation drawing for explaining the operations when the upper frame is set at the shutting position in embodiment 1;

FIG. 16 is a front drawing showing the main part of a reversing unit of the present invention in embodiment 2, which is placing in a situation whose upper frame is set at a shutting position; and

FIG. 17 is a front drawing showing the main part of a reversing unit of the present invention in embodiment 3, which is placing in a situation whose upper frame is set at a shutting position.

### DETAILED DESCRIPTION OF THE PREFERRED EMBODIMENTS

With respect to embodiments of the present invention, while referring to diagrams, the following is to explain them in detail.

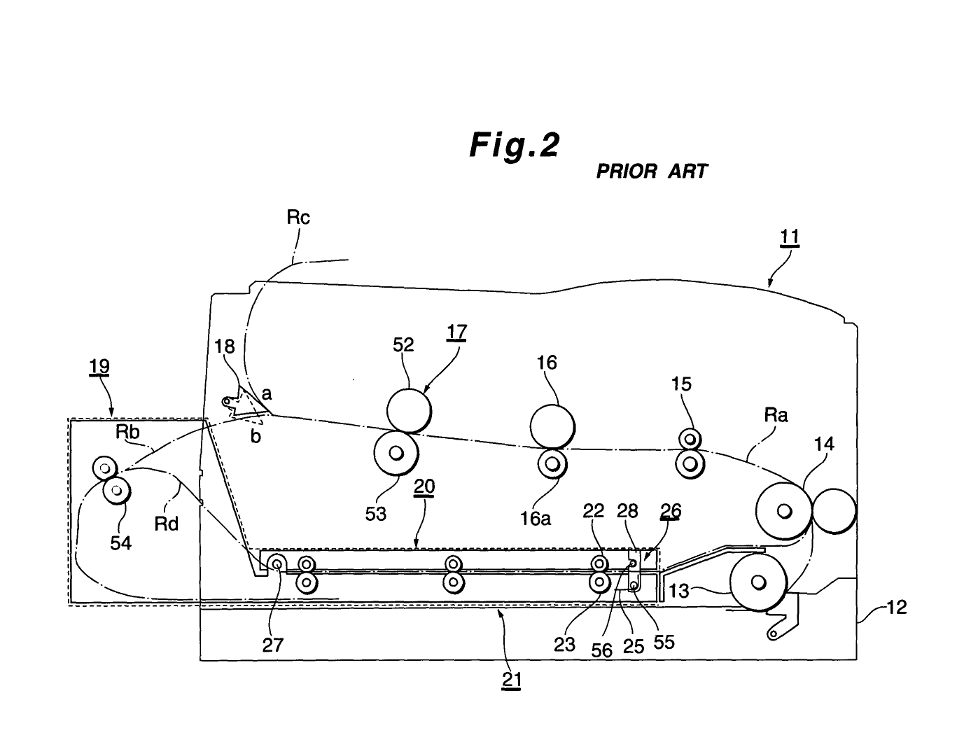

In embodiments, serving as a recording apparatus, a printing apparatus will be explained. With respect to some same construction elements as that in conventional printing apparatus, FIG. 2 will be used and some same explanations will be omitted.

<Embodiment 1>

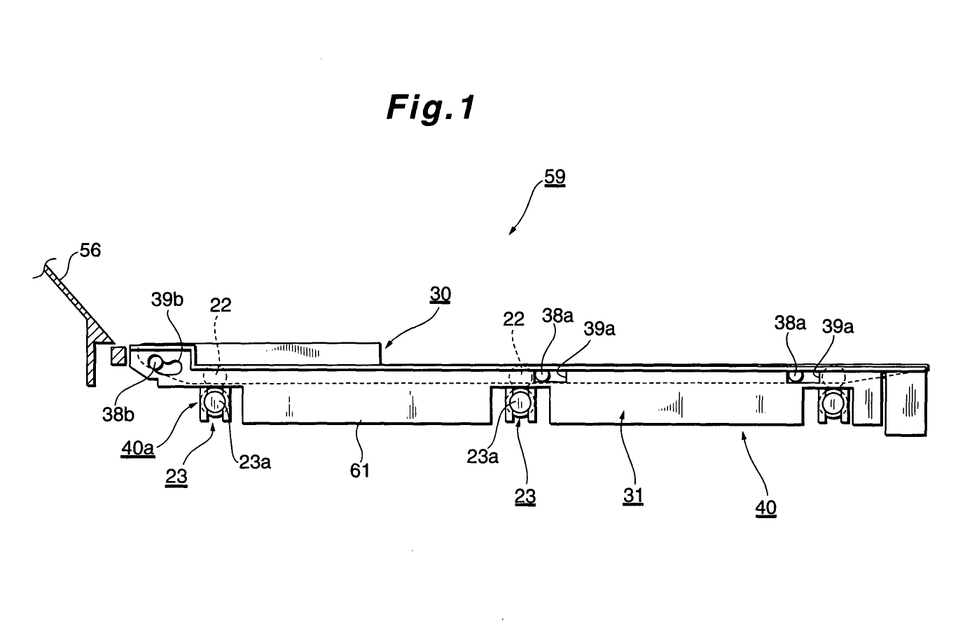

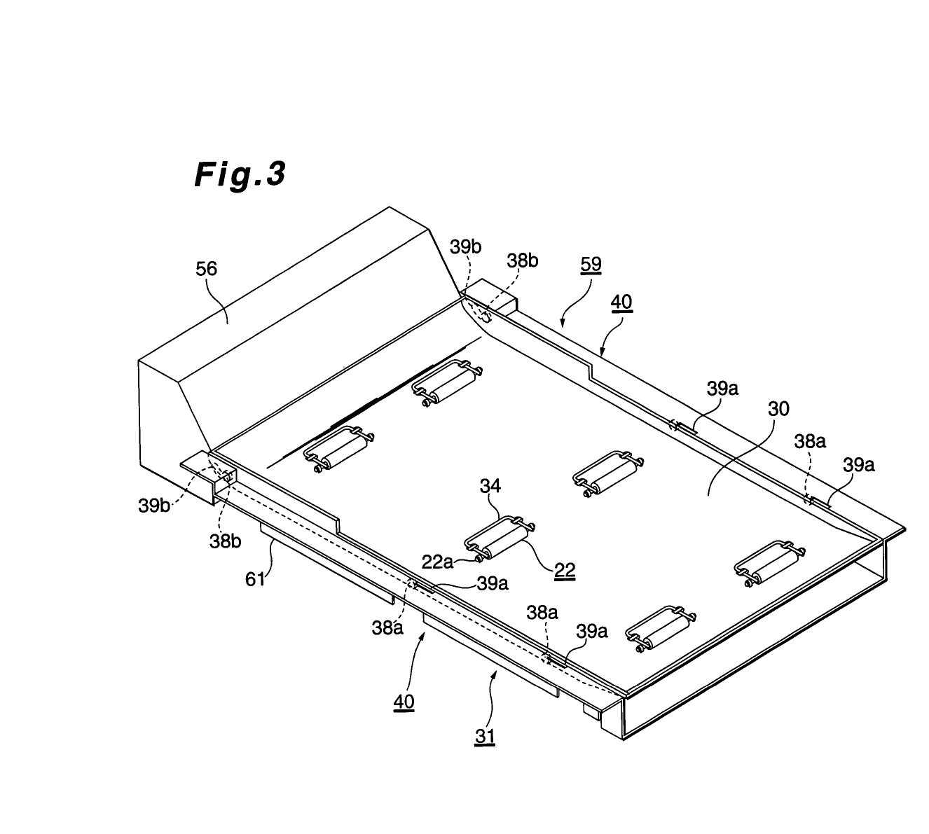

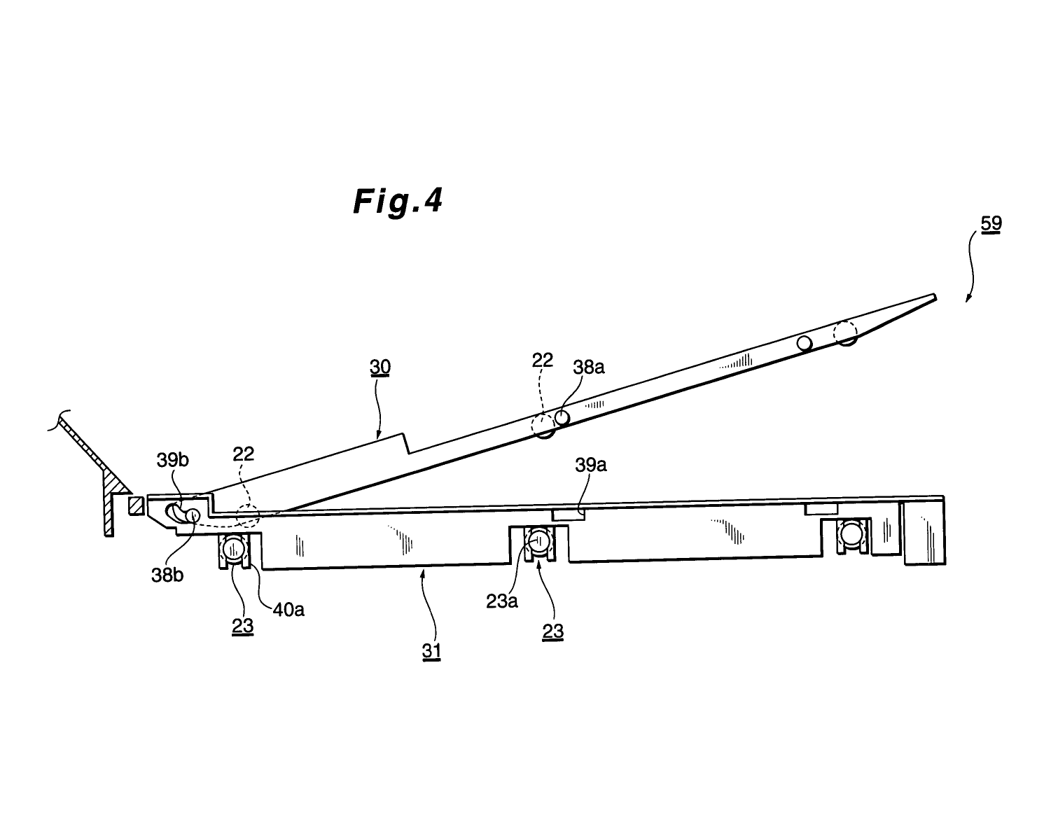

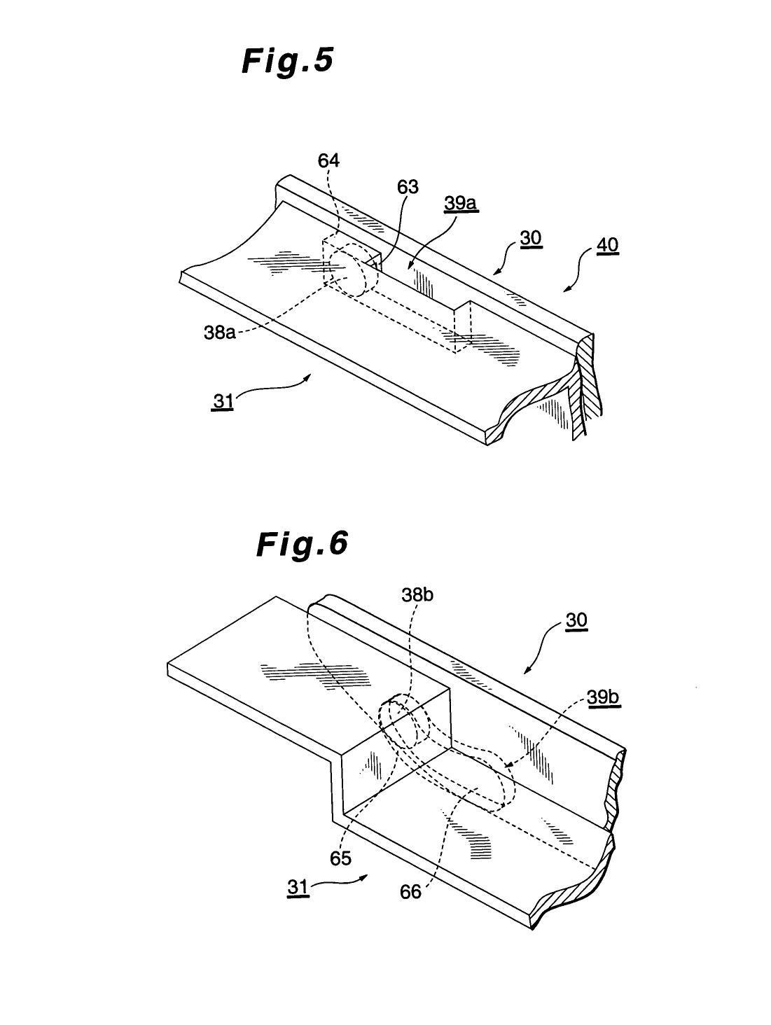

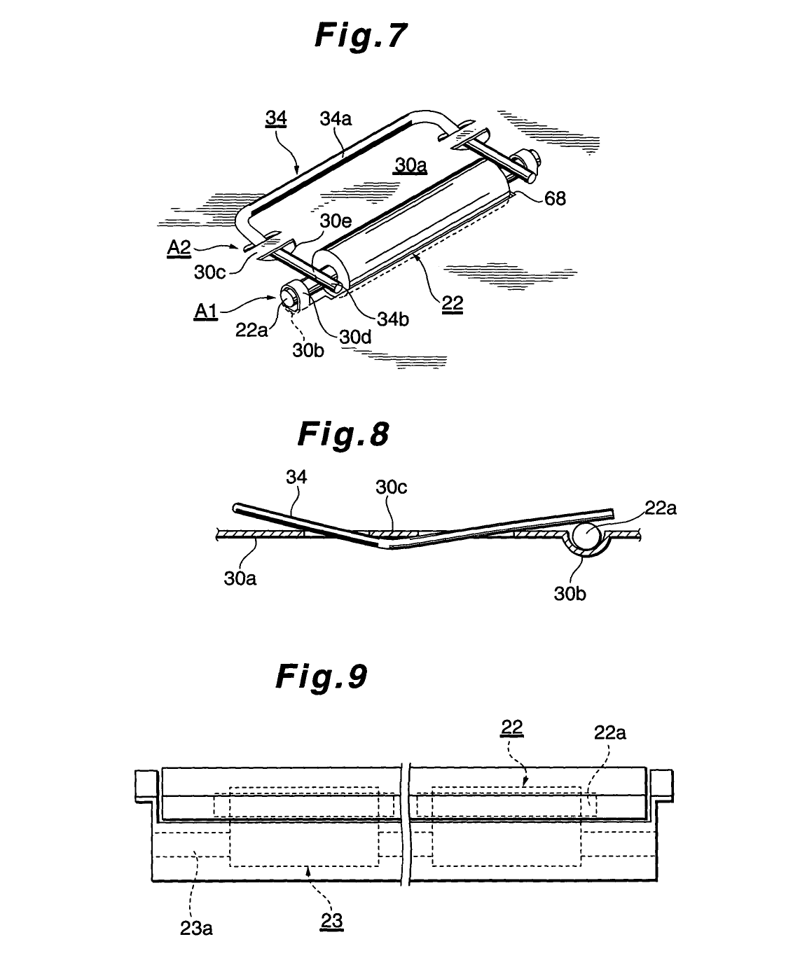

FIG. 1 is a front drawing showing the main part of a reversing unit of the present invention in embodiment 1, which is placing in a situation whose upper frame is set at a shutting position; FIG. 2 is a summary drawing showing a conventional printing apparatus; FIG. 3 is a perspective drawing showing the main part of the reversing unit in embodiment 1; FIG. 4 is a front drawing showing the main part of a reversing unit of the present invention in embodiment 1, which is placing in a situation whose upper frame is set at a opening position; FIG. 5 is a first perspective drawing showing the coupling situation of a projecting section of the present invention in embodiment 1; FIG. 6 is a second perspective drawing showing the coupling situation of a projecting section of the present invention in embodiment 1; FIG. 7 is a perspective drawing showing the setting situation of a pinch roller of the present invention in embodiment 1; FIG. 8 is a cross-sectional drawing showing the setting situation of a pinch roller of the present invention in embodiment 1; and FIG. 9 is a explanation drawing indicating the relation between a pinch roller and a conveyance roller of the present invention in embodiment 1.

In these drawings, 59 is a reversing unit to serve as a medium conveying unit for duplex printing. The reversing unit 59 is set above the sheet cassette 12 serving as a medium supplying section, such as being pulled out freely with respect to the printing apparatus 11. The reversing unit 59 comprises a upper frame 30 and a under frame 31, reverses sheet as medium and conveys the reversed sheet.

The under frame 31 includes a accommodating section 56 for accommodating the reversing roller 54; a bottom plate 61 extending from the bottom portion of the accommodating section 56 along the conveyance direction of sheet; and two side plates 40 extending upward from the both edges of the bottom plate 61.

On each side plate 40, a plurality of first ditches 39a as first ditch portions and a second ditch 39b as second ditch portion are respectively formed. The first ditches 39a are formed respectively at the center and the downstream according to the conveyance direction of sheet, and the second ditch 39b is formed at the upstream according to the conveyance direction of sheet and has a curve shape.

Moreover, the upper frame 30, the under frame 31 and the like constructed a medium supplying apparatus. further, the under frame 31 serves as first frame, and the upper frame 30 serves as second frame.

The upper frame 30 is set such as rotating freely and being installed or removed freely with respect to the under frame 31. Accordingly, corresponding to the second ditch 39b, according to the conveyance direction of sheet, at the upstream side of the upper frame 30, a projecting section 38b is formed to serve as a rotating fulcrum. The projecting section 38b is mounted into the ditch 39b. When the upper frame 30 is opened or shut, the projecting section 38b and the ditch 39b formed the rotating fulcrum.

Further, corresponding to the first ditches 39a, according to the conveyance direction of sheet, at the center and the downstream side of the upper frame 30, projecting sections 38a are formed. Thus, when the upper frame is set at the shutting position as shown by FIG. 1, the projecting section 38a just fits into the ditch 39a, that is, the projecting section 38a is coupled with the ditch 39a. Thereby, the upper frame 30 is placed in the situation being locked. That is, the upper frame 30 is fixed on the under frame 31.

Moreover, the ditch 39a serves as a first lock coupling section, the projecting section 38a serves as a second lock coupling section, the ditch 39b serves as a first fulcrum coupling section, and the projecting section 38b serves as a second fulcrum coupling section.

The ditch 39a and the projecting section 38a are selectively coupled each other when the upper frame 30 moves along the horizontal direction with respect to the under frame 31. Thus, the upper frame 30 can be lock or unlocked. Accordingly, the ditch 39a, as shown by FIG. 5, opens upward on the upper edge of the side plate 40. The ditch 39a includes an accepting portion 63 for accepting the projecting section 38a, and a fitting portion 64 which is formed at the upstream side of the accepting portion 63 according to the conveyance direction of sheet and is used for making the projecting section 38a be coupled with the ditch 39a when the upper frame 30 is placed at the shutting position.

Further, a shown by FIG. 6, the ditch 39b includes a first fitting portion 65 used for regulating the rotation operation of the upper frame 30 with respect to the under frame 31, and a second fitting portion 66 used for allowing the rotation operation of the upper frame 30 with respect to the under frame 31. When locking the upper frame 30 on the under frame 31, the projecting section 38a fits into the first fitting portion 65; and when unlocking the upper frame 30 from the under frame 31 so as to make the upper frame 30 open and shut freely, the projecting section 38a fits into the second fitting portion 66. Moreover, as compared with the ditch 39a, on the ditch 39b, no any opening part is formed. Thereby, when assembling, the projecting 38b is inserted into the ditch 39b from the inside of the side plate 40 of the under frame 31.

Further, on the upper frame 30, along the conveyance direction, three pairs of pinch rollers 22 are set such as rotating freely, and each pair of the pinch rollers 22 is symmetrical on right and left direction (that is, there are six pinch rollers 22 that are set symmetrically on right and left direction). On the under frame 31, corresponding to each pinch roller 22, six conveyance rollers 23 are installed such as rotating freely. The conveyance rollers 23 constructed a first rotating section and the pinch rollers 22 constructed a second rotating section, that is, a pressing member.

On the pinch roller 22, a axis 22a is provided. The axis 22a is supported and is pressed downward to the conveyance roller 23 by a spring 34. The spring 34 indicates a curve bar shape, has a basic part 34a and both arm parts 34b which extends from the basic part 34a and is at right angle to the basic part 34a. The edge of the arm part 34b is mounted at the either of ends of the axis 22a.

Accordingly, on the top portion 30a of the upper frame 30, a receiving portion 68 with rectangular window shape is formed such as being cut for receiving the pinch roller 22. Further, a first supporting portion A1 for supporting the pinch roller 22 to rotating freely, and a second supporting portion A2 for supporting the spring 34 are formed by cutting.

The first supporting portion A1 is formed from a curve part 30b formed by transforming downward the part of the top portion 30a, corresponding to the axis 22a, into a semicircular shape; and a holding part 30d which is next to the curve part 30b and is formed by transforming upward into a semicircular shape. Then, by inserting the axis 22a into between the curve part 30b and the holding part 30d, the pinch roller 22 is supported such as rotating freely. Moreover, the holding part 30d is formed such leaving some leeway for making the axis 22a move freely along the vertical direction.

Further, the second supporting portion A2 is formed from a holding part 30c formed by cutting the part corresponding to the arm part 34b into a belt shape; and a curve part 30e which is next to the holding part 30c and is formed by transforming downward into a semicircular shape. Then, by inserting the arm part 34b into between the holding part 30c and the curve part 30e, the spring 34 is fixed at the upper frame 30.

Thus, after the tip of each arm part 34b is pressed into the axis 22a, the pinch roller 22 follows downward by the spring force of the spring 34.

Moreover, on the side plate 40, three supporting portions 40a are formed such as opening downward. By making the axis 23a be coupled with the supporting portion 40a, the conveyance roller 23 is supported such as rotating freely. The conveyance roller 23 and the pinch roller 22 are set such as they are pressed or separated freely each other. When the projecting section 38a fits into the ditch 39a, the conveyance roller 23 is pressed by the pinch roller 22. Accordingly, the width of the both tips of the supporting portion 40a is set such as being smaller than the diameter of the axis 23a. Moreover, the axis 23a is formed by an elastic material, and the conveyance roller 23 is supported elastically with respect to the under frame 31.

Next, to explain the operations when locking the upper frame 30 on the under frame 31.

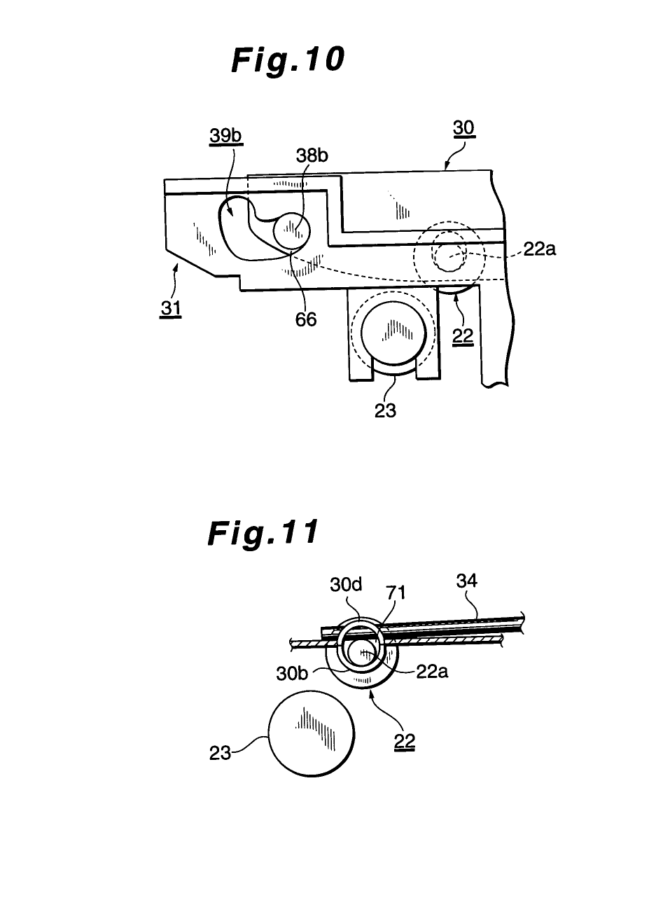

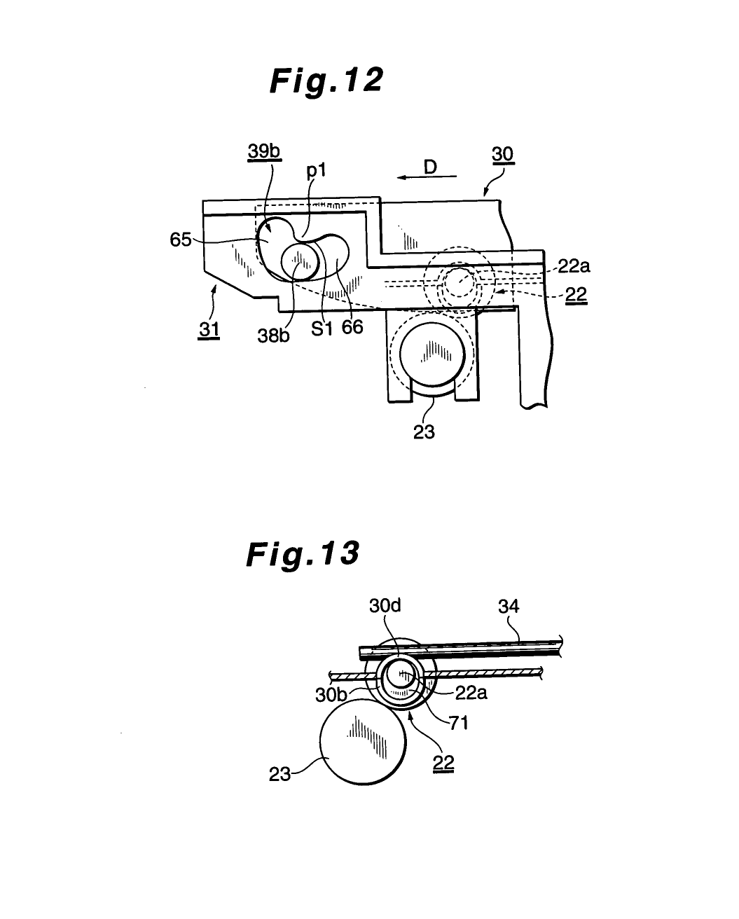

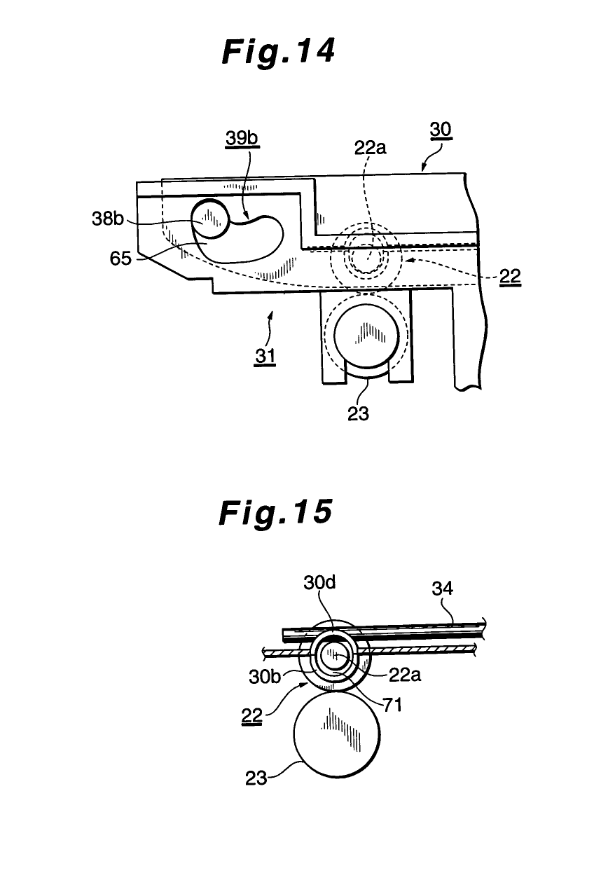

FIG. 10 is a first explanation drawing for explaining the operations when the upper frame is set at the shutting position in embodiment 1; FIG. 11 is a second explanation drawing for explaining the operations when the upper frame is set at the shutting position in embodiment 1; FIG. 12 is a third explanation drawing for explaining the operations when the upper frame is set at the shutting position in embodiment 1; FIG. 13 is a fourth explanation drawing for explaining the operations when the upper frame is set at the shutting position in embodiment 1; FIG. 14 is a fifth explanation drawing for explaining the operations when the upper frame is set at the shutting position in embodiment 1; and FIG. 15 is a sixth explanation drawing for explaining the operations when the upper frame is set at the shutting position in embodiment 1.

On the one hand, FIGS. 10 and 11 indicated such situation the upper frame 30 is being unlocked with respect to the under frame 31. In this case, the projecting section 38b fits into the second fitting portion 66 of the ditch 39b, and pinch roller 22 is separated from the conveyance roller 23. Moreover, the axis 22a of the pinch roller 22, as shown by FIG. 11, is set in between the curve part 30b and the holding part 30d and is pressed downward by the spring 34 in the hole 71 having an near elliptic shape.

Further, as shown by FIG. 12, when the upper frame 30 is moved along an arrow direction D, the projecting section 38b is moved toward the first fitting portion 65 from the second fitting portion 66, along a slanting plane S1 of a convex portion P1 formed in between the first fitting portion 65 and the second fitting portion 66 of the ditch 39b. At that time, as shown by FIG. 13, the pinch roller 22 become contacting with the conveyance roller 23, and the axis 22a of the pinch roller 22 is moved upward by the elastic force of the spring 34 in the hole 71.

On the other hand, FIGS. 14 and 15 indicated the situation that the upper frame 30 is locked on the under frame 31 and is placed at the shutting position.

In the case, the projecting section 38b fits into the first fitting portion 65 of the ditch 39b, and pinch roller 22 is pressed against the conveyance roller 23. Moreover, though the axis 22a of the pinch roller 22, as shown by FIG. 15, is pressed downward by the spring 34 in the hole 71, because the pinch roller 22 and the conveyance roller 23 are pressed each other, so the axis 22a is placed, against the elastic force of the spring 34, at the upper position above the bottom side of the hole 71.

Because the first fitting portion 65 is stopped upward, in the situation that the upper frame 30 is locked on the under frame 31, the opening or shutting operations of the upper frame 30 are controlled.

Further, by pressing downward the upper frame and moving it along the opposite direction to the arrow direction D, the upper frame 30 is unlocked with respect to the under frame 31. Thus, it is possible to open the upper frame 30.

Therefore, when the reversing unit 59 is clogged with sheet, first to pull out the reversing unit 59 from the printing apparatus 11, then, if only to press downward the upper frame 30 and move it along the opposite direction to the arrow direction D, the upper frame 30 can be unlocked with respect to the under frame 31. Then, by placing the upper frame 30 at an opening position, it is possible to remove the sheet.

As described above, in the embodiment, if only moving the upper frame 30 along the almost horizontal direction, the upper frame 30 can be locked or unlocked with respect to the under frame 31. Thereby, not only the parts number for opening and shutting the upper frame 30 can be reduced, but also the work for opening and shutting the upper frame 30 can be simplified. Therefore, even if the reversing unit 59 is clogged with sheet, the work for removing the sheet can be also simplified.

Further, because the upper frame 30 can be locked certainly on the under frame 31, it is possible to prevent that the sheet is sent slantingly or badly from happening.

In the embodiment 1, the pinch roller 22 serving as rotating section included in the upper frame 30, is used as a member to press against the conveyance roller 23 of the under roller 31. To replace the pinch roller 22, such member as pressing member which is not a rotating section but can make the conveyance roller 23 be pressed, also can be used.

Further, in the embodiment 1, the plural pinch rollers 22 are formed such as corresponding to respective conveyance rollers 23. To replace these pinch rollers 22, serving as a pressing member, a plate member to contact with all the plural conveyance rollers 23 also can be used.

<Embodiment 2>

Next, to explain the embodiment 2 of the present invention. Moreover, in the embodiment, regarding the same construction elements as that in the above embodiment, the same mark is used, and regarding some same explanations, it is omitted.

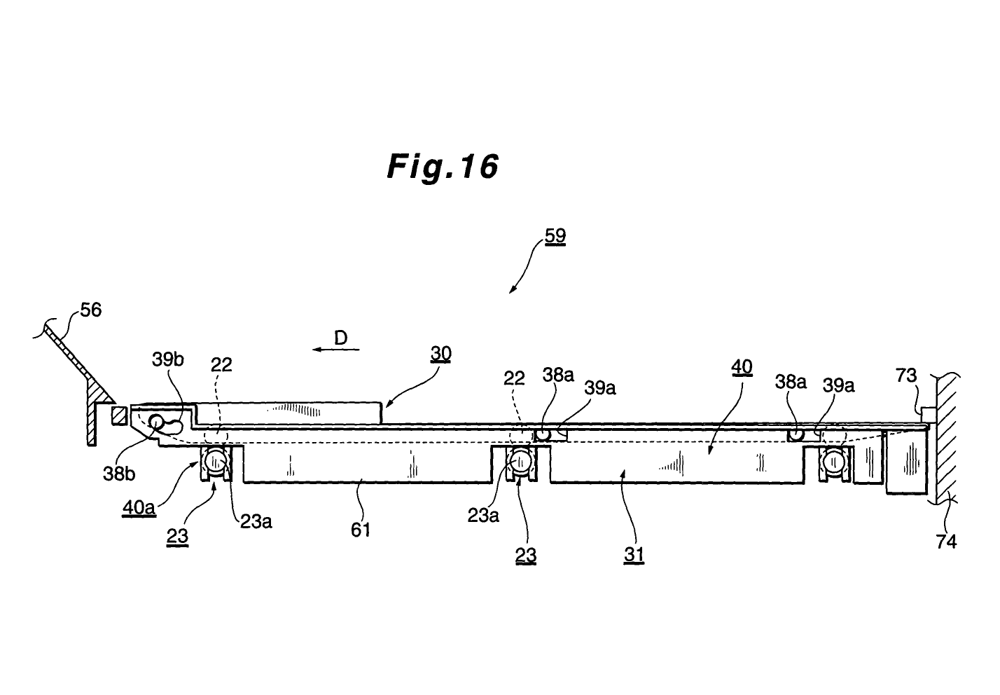

FIG. 16 is a front drawing showing the main part of a reversing unit of the present invention in embodiment 2, which is placing in a situation whose upper frame is set at a shutting position.

In FIG. 16, 73 is a contacting section formed at a predetermined position i.e. the front edge (in Fig., the right edge) of the upper frame 30 serving as a second frame; 74 is a wall section as a restricting section which is formed at a predetermined position of the printing apparatus 11 (referring to FIG. 2) serving as a recording apparatus such as facing to the contacting section 73, and has a stopper function.

In such case, after removed the sheet serving as medium, when pushing forward (in Fig., toward the right) the reversing unit 59 serving as a medium conveyance unit, the contacting section 73 contacts with the wall section 74. Thus, while the upper frame 30 is restricted to further move forward, the under frame 31 serving as a first frame can be further moved forward. Thereby, the upper frame 30 become moving along the arrow direction D with respect to the under frame 31.

As a result, the upper frame 30 is locked on the under frame 31 and is placed in a situation being placed at a shutting position.

As stated above, by moving the reversing unit 59, the upper frame 30 can move with respect to the under frame 31 along the almost horizontal direction, and the fitting situation of the ditch 39a serving as a first lock coupling section and the projecting section serving as a second lock coupling section can be changed. Thereby, after removed the sheet, if only pushing forward the reversing unit 59, the upper frame 30 can be locked on the under frame 31. Therefore, the work for shutting the upper frame 30 and the work for removing the sheet can be more simplified.

Further, when setting the reversing unit 59 into the printing apparatus 11, because the upper frame 30 can be locked naturally on the under frame 31, it is nothing to forget to lock the upper frame 30.

<Embodiment 3>

Next, to explain the embodiment 3 of the present invention. Moreover, in the embodiment, regarding the same construction elements as that in the above embodiments, the same mark is used, and regarding some same explanations, it is omitted.

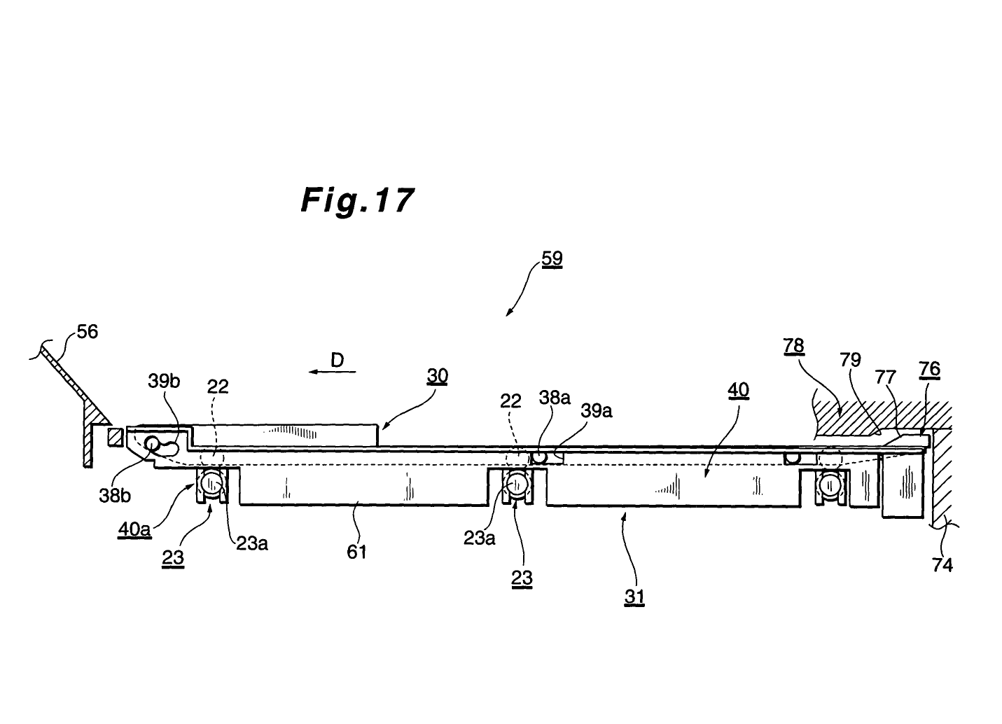

FIG. 17 is a front drawing showing the main part of a reversing unit of the present invention in embodiment 3, which is placing in a situation whose upper frame is set at a shutting position.

In FIG. 17, 76 is a contacting section formed at a predetermined position i.e. the front edge (in Fig., the right edge) of the upper frame 30 serving as a second frame; 74 is a wall section as a first restricting section which is formed at a predetermined position of the printing apparatus 11 (referring to FIG. 2) serving as a recording apparatus such as facing to the contacting section 76, and has a stopper function; and 78 is a wall section as a second restricting section which is formed at a predetermined position of the printing apparatus 11 such as being set above the upper frame 30, and has an inclination function.

On the behind edge (in Fig., the left edge) of the contacting section 76, an inclined plane 77 as a first inclining portion is formed. on the wall section 78, corresponding to the inclined plane 77, an inclined plane 79 as a second inclining portion is also formed.

In such case, when the reversing unit 59 serving as a medium conveyance unit is clogged with sheet, while pulling the reversing unit 59 out from the printing apparatus 11, the upper frame 30 moves backward (in Fig., toward the left). Then, while the inclined plane 79 is touched by the inclined plane 77, the upper frame 30 is pressed downward. Thus, the upper frame 30 is unlocked with respect to the under frame 31 serving as a first frame, and it is possible to place the upper frame 30 at the opening position and to remove the sheet. Moreover, by setting smaller the respective inclination angles of the inclined planes 77 and 79, the upper frame 30 can be moved backward by a smaller force.

Then, after removed the sheet serving as medium, when pushing forward (in Fig., toward the right) the reversing unit 59 serving as a medium conveyance unit, the contacting section 76 contacts with the wall section 74. Thus, while the upper frame 30 is restricted to further move forward, the under frame 31 serving as a first frame can be further moved forward. Thereby, the upper frame 30 become moving along the arrow direction D with respect to the under frame 31. As a result, as stated in embodiment 2, the upper frame 30 is locked on the under frame 31 and is placed in a situation being placed at a shutting position.

As stated above, by moving the reversing unit 59, the upper frame 30 can move with respect to the under frame 31 along the almost horizontal direction and the almost vertical direction, and the fitting situation of the ditch 39a serving as a first lock coupling section and the projecting section serving as a second lock coupling section can be changed. Thereby, if only pulling out the reversing unit 59, the upper frame 30 can be unlocked with respect to the under frame 31. Then, after removed the sheet, if only pushing forward the reversing unit 59, the upper frame 30 can be locked on the under frame 31. Therefore, the work for shutting the upper frame 30 and the work for removing the sheet can be more simplified.

Further, when setting the reversing unit 59 into the printing apparatus 11, because the upper frame 30 can be locked naturally on the under frame 31, it is nothing to forget to lock the upper frame 30.

According to the present invention, the medium supplying apparatus comprises a first frame and a second frame set such as rotating freely with respect to the first frame. The first frame includes a first rotating section set such as rotating freely, a first fulcrum coupling section constructing a rotating fulcrum and a first lock coupling section. The second frame includes a pressing member, a second fulcrum coupling section constructing the rotating fulcrum by being coupled with the first fulcrum coupling section, and a second lock coupling section coupled selectively with the first lock coupling section.

Further, the first and second lock coupling sections are coupled selectively by relative movement. Thus, the second frame is locked or unlocked with respect to the first frame.

Thereby, not only the parts number for opening and shutting the second frame can be reduced, but also the work for opening and shutting the second frame can be simplified. Therefore, even if the medium conveyance unit is clogged with medium, the work for removing the medium can be also simplified.

Further, because the second frame can be locked certainly on the first frame, it is possible to prevent that the sheet is sent slantingly or badly from happening.

The present invention is not limited to the foregoing embodiments but many modifications and variations are possible within the spirit and scope of the appended claims of the invention.

What is claimed is:

1. An medium supplying apparatus, comprising:
a first frame which includes a first rotating section set such as rotating freely, a first fulcrum coupling section constructing a rotating fulcrum and a first lock coupling section;
a second frame which is set such as rotating freely with respect to said first frame and which includes a pressing member, a second fulcrum coupling section constructing said rotating fulcrum by being coupled with said first fulcrum coupling section, and a second lock coupling section coupled selectively with said first lock coupling section,
wherein said first lock coupling section and said second lock coupling section are coupled selectively by relative movement so as to lock or unlock said second frame with respect to said first frame.

2. The medium supplying apparatus according to claim 1,
wherein said first rotating section and said pressing member are coupled while said first lock coupling section and said second lock coupling section are coupled, a medium is conveyed by said first rotating section.

3. The medium supplying apparatus according to claim 1,
wherein said first fulcrum coupling section includes a first fitting portion used for regulating the rotation operations of said second frame with respect to said first frame, and a second fitting portion used for allowing the rotation operations of said second frame with respect to said first frame.

4. The medium supplying apparatus according to claim 1,
wherein said first lock coupling section includes an accepting portion for accepting said second lock coupling section, and a fitting portion coupled with said second lock coupling section.

5. The medium supplying apparatus according to claim 1,
wherein said first frame and said second frame construct a medium conveyance unit, said second frame is moved with respect to said first frame and the coupling situation of said first lock coupling section and said second lock coupling section is changed, by moving said medium conveyance unit.
